(19) United States
(12) Patent Application Publication
(10) Pub. No.: US 2004/0121923 A1
(43) Pub. Date: Jun. 24, 2004

(54) Contact lens care compositions containing chitin derivatives

(76) Inventors: Bor-Shyue Hong, Arlington, TX (US); David L. Meadows, Colleyville, TX (US); Howard Allen Ketelson, Fort Worth, TX (US); Geoffrey Robert Owen, Southlake, TX (US)

Correspondence Address: ALCON RESEARCH, LTD., R&D COUNSEL, Q-148, 6201 SOUTH FREEWAY, FORT WORTH, TX, 76134-2099, US

(21) Appl. No.: 10/732,603

(22) Filed: Dec. 10, 2003

Related U.S. Application Data
(60) Provisional application No. 60/436,164, filed on Dec. 23, 2002.

(51) Int. Cl. C11D 1/00

(52) U.S. Cl. 510/112

(57) ABSTRACT

The use of compositions containing chitin derivatives to treat contact lenses is described. The compositions are particularly useful for removing protein deposits from contact lenses, but also serve to lubricate the surfaces of the lenses and enhance the comfort of the lenses when worn on the eyes. The chitin derivatives are preferably nonionic (e.g., ethylene glycol chitin), and facilitate the removal of protein deposits from contact lenses by functioning as a substrate for the lysozyme contained in those deposits.

### CLAIM FOR PRIORITY

This application claims priority from U.S. Ser. No. 60/436,164, filed Dec. 23, 2002.

### BACKGROUND OF THE INVENTION

The present invention is directed to the field of products for treating contact lenses. The invention is particularly directed to enhancement of the cleaning of contact lenses, and to the improvement of the comfort of the lenses when worn on the eye.

Various compositions and methods have been utilized to clean contact lenses prior to the present invention. The prior compositions and methods have included cleaning agents such as surfactants, chelating agents and proteolytic enzymes. The present invention is particularly directed to the removal of protein deposits from contact lenses. The principal component of such deposits is lysozyme.

Lysozyme is one of the major proteinaceous components in human tears. It is an enzyme that acts as an antimicrobial agent by degrading glycosidic linkages between N-acetylmuramic acid and N-acetylglucosamine units of the microbial cell wall. Thus, the presence of lysozyme in human tears is a natural defense mechanism against ocular infections. Unfortunately, when contact lenses are placed on the eye, prolonged bathing of the lenses by the tears leads to deposits of lysozyme on the lenses. Lysozyme is a protein, and the deposits of lysozyme on contact lenses are typically composed of a mixture of proteins, lipids and other materials. These deposits become bound to the lenses, and consequently are very difficult to remove.

The use of proteolytic enzymes (e.g., pancreatin) to remove protein deposits from contact lenses has been fairly effective. However, the treatment of contact lenses with cleaning compositions containing proteolytic enzymes is considered by some contact lens wearers to be undesirable, in view of cost, convenience and other factors. Consequently, the use of proteolytic enzyme products to remove protein deposits from contact lenses has declined greatly over the past decade. These products have largely been replaced by complexing agents contained in “multi-purpose” solutions that are used to clean and disinfect contact lenses on a daily basis. For example, U.S. Pat. No. 5,858,937 (Richard, et al.) describes the use of polymeric phosphonates in multi-purpose solutions to remove protein deposits, and U.S. Pat. No. 5,370,744 (Chowhan, et al.) describes the use of carboxylates (e.g., citrate) for the same purpose. Although multi-purpose solutions containing such complexing agents have been commercially successful, there is a need for improved solutions, particularly solutions that are more effective in preventing and removing protein deposits. The present invention addresses this need.

The present invention is based on a discovery that chitin and chitin derivatives are effective in removing protein deposits from contact lenses through the formation of an enzyme-substrate complex on the lenses. It has also been found that chitin and derivatives thereof enhance the lubricity of contact lenses and protect corneal epithelial cells from desiccation. All of these functions promote the ocular comfort of persons wearing contact lenses.

The following publications may be referred to for further background regarding chitin and its derivatives:

Yamada, H and Imoto, T. “A convenient synthesis of glycolchitin, a substrate of lysozyme”, Carbohydrate Research, 92,160-162 (1981).

Senju, R. and Okimasu, S. “Studies on Chitin. Part I. On the Glycolation of Chitin and the Chemical Structure of Glycol chitin”, J. of the Agricultural Chemical Society of Japan, 23, 432-437 (1950).

Kurita, K. “Chemical Modification of Chitin”, J. of Synthetic Organic Chemistry Japan), 42, 567-574 (1984).

Tokura, S., Nishi, N., Tsutaumi, A., and Somori, O. “Studies on Chitin VIII. Some Properties of Water Soluble Chitin Derivatives”, Polymer J, 15, 485-489 (1983).

Nishimura, S -I., Nishi, N., and Tokura, S. “Bioactive Chitin Derivatives. Activation of Mouse-peritoneal macrophages by O-(Carboxymethyl) Chitins”, Carbohydrate Research, 146, 251-258 (1986).

Hjerde, R. J. N., Varum, K. M., Grasdalen, H., Tokura, S., and Smidsrod, O. “Chemical composition of O-(carboxymethyl)-chitins in relation to lysozyme degrdation rates”, Carbohydrate Polymers, 34, 131-139 (1997).

Stokke, B. T., Varum, K. M., Holme, H. K., Hjerde, R. J. N., and Smidsrod, O. “Sequence specificities for lysozyme depolymerization of partially N-acetylated chitosans”, Can. J. Chem., 73, 1972-1981 (1995).

Nordtveit, R. J., Varum, K. M., and Smidsrod, O. “Degradation of fully water-soluble, partially N-acetylated chitosans with lysozyme”, Carbohydrate Polymers, 23, 253-260 (1994).

Dung, P., Milas, M., Rnaudo, M., and Desbrieres, J. “Water soluble derivatives obtained by controlled chemical modifications of chitosan”, Carbohydrate Polymers, 24, 209-214 (1994).

Kristiansen, A., Varum, K. M., and Grasdalen, H. “Competitive binding of highly de-N-acetylated chitosans and N,N′-diacetylchitobiose to lysozyme from chickrn egg white syudied by ¹H NMR spetroscopy”, Carbohydrate Research, 289, 143-150 (1996).

Hayshi, K., Yamasaki, N. and Funatsu M. “Muramidase catalyzed hydrolysis of glycol chitin” Agr. Biol. Chem., 28, 517-523 (1964).

Hayshi, K., Fujimoto, N., Kugimiya, M. and Funatsu M., “The enzyme-substrate complex of lysozyme with chitin derivatives”, J. Biochemistry, 65, 401-405 (1969).

Bernkop-Schnurch, A. and Kast, C. E., “Chemically modified chitosans as enzyme inhibitors”, Adv. Drug Deli. Rev. 52,127-137 (2001).

Chitin is a naturally occurring biopolymer found in the shells of crustaceans such as shrimp, crab, and lobster, and can be isolated from these shells using aqueous solutions that are highly acidic or highly basic. Since the chitin obtained from such sources is not normally soluble in aqueous solutions at neutral pH, various chemical modifications have been adopted to enhance the solubility of chitin for commercial applications. For example, chitin can be deacetylated to obtain chitosan, which is relatively soluble in aqueous compositions. Derivatives of chitin having improved aqueous solubility can also be prepared by means of glycolation, glycation, carboxymethylation and other similar chemical modifications known to those skilled in the art.

Since chitin is a linear polymer formed through β-(1→4) glycosidic linkage of the monomeric N-acetyl-D-glucosamine and bears a structural resemblance to the polysaccharides found in microbial cell walls, it is susceptible to binding with lysozyme and degradation at its N-acetylglucosamine units that are joined by β-(1→4) glycosidic bonds. Chitin derivatives that are soluble in aqueous media, such as ethylene glycol chitin, have therefore been used as a substrate for the quantitative assessment of lysozyme activity.

Possible industrial uses of chitin and chitin derivatives have been described in several prior patent publications. Those publications indicate that chitin and its derivatives may be useful as a component of detergents and cosmetics, as well as vehicles for delivering drugs to the eye and other tissues. The formation of contact lenses from chitin or chitin derivatives has also been proposed. The following patent publications may be referred to for further background regarding such prior uses or proposed uses of chitin and its derivatives:

U.S. Pat. No. 4,826,826 (Conti);

European Patent Application Publication No. 0 356 060 (Mosbey);

International Publication No. WO 00/60038(Cantoro);

International Publication No. WO 00/30609 (Gurny, et al.);

International Publication No. WO 94/13774 (Powell, et al.);

U.S. Pat. No. 5,773,021 (Gurtler, et al.);

European Patent Application Publication No. 0 737 602 (Gruber);

U.S. Pat. No. 5,747,475 (Nordquist, et al.);

U.S. Pat. No. 5,015,632 (Nelson);

U.S. Pat. No. 5,422,116 (Yen, et al.);

International Publication No. WO 00/14155 (Ucheegbu);

Japanese Patent Publication No. JP 63193999 (Kao Corp.);

Japanese Patent Publication No. JP 63096111 (Kanebo Ltd.);

Japanese Patent Publication No. JP 59106409 (Ichimaru Pharcos. Inc.); and

Japanese Patent Publication No. JP 56094322 (Mitsubishi Rayon Co., Ltd.).

The use of chitosan or chitosan derivatives to help preserve solutions from microbial contamination is described in United States Patent Application Publication No. US 2002/0177577 A1.

### SUMMARY OF THE INVENTION

The present invention is based on the finding that certain chitin derivatives can function as a substrate for lysozyme, and that when aqueous solutions containing these agents are applied to contact lenses, the chitin derivatives bind specifically to the lysozyme present on the lenses and form an enzyme-substrate complex. The conformational change of the lysozyme due to this complex formation provides a mechanism to lift the lysozyme from the lens surface and facilitate the cleaning of the lenses.

The chitin derivatives contained in the compositions of the present invention also exhibit a lubricating effect on the lens surface, thereby enhancing comfort for the contact lens wearer.

The chitin derivatives also stabilize the tear film and protect corneal epithelial cells from desiccation.

Based on the findings summarized above, the present invention provides contact lens care solutions that have a unique cleaning mechanism, while also providing lubrication and desiccation protection properties.

The present invention provides compositions and methods for cleaning contact lenses and enhancing the comfort of the lenses when worn on the eyes of human patients. The compositions may take various forms, such as: multi-purpose solutions for cleaning, disinfecting and storing contact lenses; in the eye cleaning products; or rewetting drops.

### DETAILED DESCRIPTION OF THE INVENTION

Chitin is a high-molecular weight linear polymer of N-acetyl-D-glucosamine (N-acetyl-2-amino-2-deoxy-D-glucopyranose) units linked by β-D(1→4) glycosidic bonds. All residues are formed entirely of N-acetyl-glucosamine. It is highly insoluble, has little chemical reactivity, and is nonionic at physiological pH levels.

Chitin is sometimes confused with chitosan, but these two materials are, in fact, quite different in several respects. Chitosan is a linear polymer of β-(1→4)-2-amino-2-deoxy-D-glucopyranose wherein all residues are comprised entirely of N-glucosamine. It is soluble and is predominantly cationic at physiological pH levels. Chitosan is not capable of performing the contact lens cleaning function described herein.

Lysozyme is known to kill microorganisms by cleaving glycosidic bonds of polysaccharides found in the cell wall. Since chitin and its derivatives have a structure resembling that of the polysaccharides found in the cell wall, these materials are also susceptible to lysozyme hydrolysis and have been used as a lysozyme substrate (e.g., ethylene glycol chitin has been widely used for quantification of lysozyme activity).

The present invention is directed to a unique method of removing protein deposits from contact lenses. The method is based on the above-discussed enzyme-substrate interaction between lysozyme and the chitin derivatives described herein. This interaction causes a change in the conformation of lysozyme that results in a loosening of the binding of lysozyme to the negatively charged surfaces of contact lenses, thereby facilitating the removal of lysozyme deposits from the lenses.

The compositions of the present invention contain one or more chitin derivatives that are soluble in aqueous solutions at a pH of from 6.5-8.5 and are capable of binding with and functioning as a substrate for lysozyme.

The chitin derivatives utilized in the present invention are preferably nonionic, so as to avoid ionic interactions with either: (i) cationic antimicrobial agents (e.g., polyquaternium-1 or PHMB) utilized in solutions for disinfecting contact lenses, or (ii) anionic sites on the polymers from which many soft contact lenses are formed. The chitin derivatives may include anionic functional groups, such as carboxylic moieties, but highly cationic derivatives, such as chitosan, are not useful in the present invention. (N-deacetylation of chitin leads to the formation of chitosan. Chitosan is partially to substantially deacetylated, relative to chitin, and unlike chitin, chitosan contains free amine groups along the polymer chain.) The chitin derivatives that include anionic groups function to remove lysozyme deposits by means of both the enzyme-substrate interaction described above and ionic interactions between the anionic groups on the chitin derivatives and cationic sites on the lysozyme.

The chitin derivatives used in the present invention include, but are not limited to, the chitin polymers modified by alkylation, acetylation, and glycolation at their hydroxy or amino groups, and the water soluble hydrolysates of chitin obtained by acid, alkaline or enzyme hydrolysis. The preferred chitin derivatives are ethylene glycol chitin, propylene glycol chitin, hydroxypropyl chitin, carboxymethyl chitin, partially deacetylated chitin, and the oligomers of chitin with from 2 to 500 N-acetylglucosamine units. The derivatives are soluble in aqueous solutions at a relatively neutral pH of from 6.5 to 8.5. The polymers have molecular weights ranging from 500 to 10,000,000 Daltons, and viscosities of from 2 to 3000 cps (at 25° C.).

The chitin derivatives that may be utilized in the present invention are either commercially available (e.g., ethylene glycol chitin is available from Seikagaku America, a Division of Associates of Cape Cod, Inc., Falmouth, Mass., and Vanson HaloSource of Redmond, Wash.; and carboxymethyl chitin, and 50% deacetylated chitin are products of KoYo Chemical Co., LTD., Tokyo, Japan); or can be prepared by means of processes that have been described in the scientific literature [e.g., Ryoichi Senju and Satoshi Okimasu, Nippon Nogeikagaku Kaishi, volume 23 pages 432-437, (1950); Keisuke Kurita, J Synthetic Organic Chemistry Japan, volume 42 pages 567-574, (1984); and Seiichi Tokura, Norio Nishi, Akihiro Tsutsumi, and Oyin Somorin, Polymer J, volume 15, pages 485-489 (1983)].

In general, the compositions of the present invention are formulated as liquids. In addition to the above-described chitin derivatives, the compositions may include various other components, such as ophthalmically acceptable disinfectants or preservatives, buffering agents, tonicity adjusting agents, surfactants, chelating and/or sequestering agents, cosolvents and the like.

The compositions of the present invention contain one or more chitin derivatives in an amount sufficient to facilitate the removal of protein deposits from contact lenses. This is referred to herein as “an effective amount”. The concentration required for a particular composition will depend on factors apparent to those skilled in the art, such as, the chitin derivative or derivatives selected for the composition, the molecular weight of the derivative(s) selected, and the viscosity desired for the composition.

The selection of an ideal molecular weight of a particular chitin derivative and the desired viscosity of the composition can be readily determined by persons skilled in the art. The compositions of the present invention will generally have viscosities in the range of 2 to 3000 cps at 25° C. The preferred viscosity range is from about 5 to 15 cps. The contact lens cleaning compositions of the present invention will generally contain one or more chitin derivatives in an amount of from about 0.01 to 10 percent by weight/volume (“w/v %”), preferably about 0.1 to 1 w/v %.

The compositions of the present invention may contain various other components in, addition to the chitin derivatives described above, such as surfactants, chelating agents, buffering agents, tonicity adjusting agents, antimicrobial preservatives and contact lens disinfecting agents.

The surfactants utilized in the compositions of the present invention can be cationic, anionic, nonionic or amphoteric. Preferred surfactants are neutral or noninonic surfactants which may present in amounts up to 5 w/v %. Examples of suitable surfactants include, but are not limited to, polyethylene glycol ethers or esters of fatty acids, polyoxyethylene-polyoxypropylene block copolymers of ethylene diamine (e.g., poloxamines such as Tetronic® 1304 or 1107), polyoxypropylene-polyoxyethylene glycol nonionic block copolymers (e.g., poloxamers, such as Pluronic® F-127), and p-isooctylpolyethylen phenol formaldehyde polymers (e.g., Tyloxapol).

Examples of preferred chelating and/or sequestering agents include ethylenediaminetetraacidic acid (EDTA) and its salts, and citric acid and its salts. Other chelating and/or sequestering agents known to those skilled in the art can also be employed. The sequestering agents are normally employed in amounts of from about 0.025 to 2.0 w/v %.

Examples of suitable cosolvents include glycerin, propylene glycol and polyethylene glycol.

Examples of suitable buffering agents which may be incorporated into the compositions include, but are not limited to, alkaline metal salts, such as potassium or sodium carbonates, acetates, borates, phosphates and citrates, and weak acids, such as acetic acids and boric acids. The preferred buffering agents are alkaline metal borates, such as sodium or potassium borates. Other pH-adjusting agents, such as inorganic acids and bases, may also be utilized. For example, hydrochloric acid, sodium hydroxide, various biological buffers (e.g., HEPES and PIPES), triethanolamine, or BIS-TRIS may be employed in concentrations suitable for ophthalmic compositions. The above-described buffering agents are generally present in amounts from about 0.1 to about 2.5 w/v %, preferably from about 0.5 to about 1.5 % w/v %.

Examples to tonicity adjusting agents include ionic agents, such as sodium chloride and potassium chloride, and nonionic agents, such as glycerol, sorbitol and mannitol. The tonicity adjusting agents are utilized to adjust the osmolality of the compositions to more closely resemble that of human tears and to be compatible with contact lens materials. The use of nonionic agents is preferred relative to compositions containing ionic antimicrobial agents (e.g., polyquaternium-1 and PHMB), so as to avoid ionic interactions that may adversely affect the activity of these agents. The compositions of the present invention will generally have an osmolality of about 200 to 400 milliOsmoles per kilogram water (“mOsm/kg”), more preferably about 280 to 320 mOsm/kg.

Suitable antimicrobial agents include, but are not limited to those generally used in multi-purpose contact lens care solutions or in other ophthalmic solutions, such as polyquaternium-1, which is a polymeric quaternary ammonium compound; myristamidopropyl dimethylamine (“MAPDA”), which is a N,N-dialkyl, N′-alkyl, ethylene diamine; polyhexamethylene biguanide (“PHMB”) or polyaminopropyl biguanide (PAPB), which is a polymeric biguanide; and hydrogen peroxide. The antimicrobial agents that may be utilized in the present invention also include the aminobiguanides described in copending U.S. patent application Ser. No. 09/581,952 and corresponding International (PCT) Publication No. WO 99/32158, the entire contents of which are hereby incorporated in the present specification by reference. The preferred antimicrobial agents are polyquaternium-1, MAPDA, and the amino biguanide identified in WO 99/32158 as “Compound Number 1”.

The compositions of the present invention that are intended for use as CLC products will contain one or more ophthalmically acceptable antimicrobial agents in an amount effective to prevent microbial contamination of the compositions (referred to herein as “an amount effective to preserve”), or in an amount effective to disinfect contact lenses by substantially reducing the number of viable microorganisms present on the lenses (referred to herein as “an amount effective to disinfect”).

The levels of antimicrobial activity required to preserve ophthalmic compositions from microbial contamination or to disinfect contact lenses are well known to those skilled in the art, based both on personal experience and official, published standards, such as those set forth in the United States Pharmacopoeia (“USP”) and similar publications in other countries.

The compositions of the present invention are preferably formulated as multi-purpose solutions for treating contact lenses, but may also be formulated as a separate cleaning product or as a product for rewetting contact lenses (e.g., rewetting drops), rather than as a multi-purpose solution.

The compositions and methods of the present invention are further illustrated by means of the examples presented below.

### EXAMPLE 1

### Representative Compositions of the Invention

The formulations shown in Tables 1 and 2 below are representative of the compositions of the present invention. All concentrations shown are expressed as weight/volume percent. The formulations were prepared in accordance with known procedures.

TABLE 1

| | Formulation Numbers/Concentrations (w/v %) | | | | | |
|---|---|---|---|---|---|---|
| Component | 9198-17C | 9198-17D | 9198-17E | 9198-17F | 9198-17H | 9198-171 |
| Polyquaternium-1 | 0.0011 | 0.0011 | 0.0011 | 0.0011 | 0.0011 | 0.0011 |
| Sodium Citrate | | 0.6 | | 0.6 | | |
| Sorbitol | 1.5 | 1.5 | 1.5 | 1.5 | 1.5 | 1.5 |
| Boric Acid | 0.6 | 0.6 | 0.6 | 0.6 | 0.6 | 0.6 |
| Sodium Chloride | 0.32 | 0.32 | 0.32 | 0.32 | 0.32 | 0.32 |
| Ethylene Glycol Chitin | 0.2 | 0.2 | | | 0.5 | |
| Carboxymethyl Chitin | | | 0.2 | 0.2 | | 0.5 |
| pH | 7.0 | 7.0 | 7.0 | 7.0 | 7.0 | 7.0 |

Two vehicles were also prepared, but are not shown in the table above. The first vehicle did not contain either citrate or a chitin derivative, but was otherwise identical to the formulations shown in Table 1 above. It had a pH of 7.0 and is referred to below by means of formulation number “9198-17J”. A second vehicle was also prepared. It was identical to the first vehicle, except that it also contained 0.6 w/v % sodium citrate and had a pH of 7.5; this second vehicle is referred to below by means of formulation number “8874-90H”.

TABLE 2

| | Formulation Numbers/Concentrations (w/v %) | | | | | |
|---|---|---|---|---|---|---|
| | 8874- | 8874- | | | | |
| Component | 74EGC1 | 74EGC2 | 9198-09A | 9198-20H | 9198-09E | 9198-09H |
| Boric acid | 0.6 | 0.6 | 0.6 | 0.6 | 0.6 | 0.6 |
| Sorbitol | 1.5 | 1.5 | 1.5 | 1.5 | 1.5 | 1.5 |
| Sodium chloride | 0.32 | 0.32 | 0.32 | 0.32 | 0.32 | 0.32 |
| Ethylene glycol chitin | 0.2 | 0.5 | | | | |
| Carboxymethyl chitin | | | 0.2 | 0.5 | | |
| 50% Deacetylated Chitin | | | | | 0.25 | |
| pH | 7.5 | 7.5 | 7.5 | 7.5 | 7.5 | 7.5 |

Formulation Number 9198-09H does not contain a chitin derivative, and therefore represents the vehicle for the other compositions described in Table 2.

### EXAMPLE 2

### Methods and Procedures for Assessment of Cleaning Efficacy

The ability of the compositions described in Example 1 to remove protein deposits from contact lenses was evaluated by means of the procedures described below.

### I. Lens Deposition Procedure

Acuvue™ lenses were selected for this evaluation. Each lens was immersed in a glass vial containing 5 ml lysozyme solution and incubated at 37° C. for 24 hours. After incubation, the deposited lenses were removed and rinsed by dipping into three consecutive beakers containing 50 ml deionized water to remove the excess lysozyme.

### II. Cleaning Procedure

The soiled lenses were soaked and shaken with 5 ml each of the test solutions in a glass vial at room temperature for 16 hours. After the soaking/cleaning period, the lenses were removed from their respective test solutions and rinsed by dipping into three consecutive beakers containing 20 mL of Unisol®4 saline solution. Mechanical rubbing of the lenses was not included as part of the cleaning regimen. (This is referred to below as the “no rub” regimen.) The cleaned lenses were then subjected to the extraction procedure described below.

### III. Extraction and Determination of Lysozyme

Both treated and non-treated (as a control) lenses were then extracted with 5 ml each of an extraction solution comprising of acetylnitrile/water/trifluoroacetic acid (500/500/1, v/v) in a glass vial. The extraction was conducted by shaking the vial with a rotary shaker at room temperature for at least 2 hours (usually overnight).

Quantitative determination of the lysozyme from the lens extract and lens soaking solution was carried out by a fluorescence spectrophotometer operated with an autosampler and computer. The fluorescence intensity of a 2 ml aliquot from each sample was measured by setting the excitation/emission wavelength at 280 nm/346 nm with excitation/emission slits of 2.5 nm/10 nm respectively, and the sensitivity of the photomultiplier was set at 950 volts.

A lysozyme standard curve was established by diluting the lysozyme stock solution to the concentrations ranging from 0 to 60 μg/ml with either the extraction solution or the individual test solution. The fluorescence measurement was carried out using the same instrumental settings as those used for the lens extracts and lens soaking solutions. The lysozyme concentration for all of the samples were calculated based on the slope developed from the linear lysozyme standard curve.

### IV. Cleaning Efficacy

The cleaning efficacy of the test solutions was determined by calculating the percentage of protein removal.

### V. Results

The results of the above-described evaluation are provided in Tables 3 and 4, below.

TABLE 3
Cleaning Efficacy of Compositions Containing Chitin Derivatives
The results obtained with the solutions described in Table 1 above
were as follows:

| Composition | % Cleaning | STDV |
|---|---|---|
| 0.2% Ethylene glycol-Chitin; no citrate | 26.3 | 1.6 |
| (9198-17C) | | |
| 0.5% Ethylene glycol-Chitin; no citrate | 28.1 | 0.4 |
| (9198-17H) | | |
| 0.2% Carboxymethyl-Chitin; no citrate | 46.1 | 0.5 |
| (9198-17E) | | |
| 0.5% Carboxymethyl-Chitin; no citrate | 46.3 | 0.3 |
| (9198-17I) | | |
| Vehicle without citrate; pH 7.0 | 8.0 | 0.2 |
| (9198-17J) | | |
| 0.2% Ethylene glycol-Chitin with citrate | 42.6 | 0.8 |
| (9198-17D) | | |
| 0.2% Carboxymethyl-Chitin with citrate | 41.9 | 2.7 |
| (9198-17F) | | |
| Vehicle with 0.6 w/v % sodium citrate; pH of 7.5 | 32.4 | 1.7 |
| (8874-90H) | | |

TABLE 4
Cleaning Efficacy of Compositions Containing Chitin Derivatives.
The results obtained with the solutions described in Table 2 above
were as follows:

| Composition | % Cleaning | STDV |
|---|---|---|
| 0.2% Ethylene glycol-Chitin (8874-74EGC1) | 28.6 | 0.2 |
| 0.5% Ethylene glycol-Chitin (8874-74EGC2) | 36.4 | 0.2 |
| 0.2% Carboxymethyl-Chitin (9198-09A) | 45.2 | 0.3 |
| 0.5% Carboxymethyl-Chitin (9198-20H) | 47.2 | 0.4 |
| 0.25% Deacetylated Chitin (50%) | 30.2 | 0.7 |
| (9198-09E) | | |
| Vehicle (9198-09H) | 8.7 | 0.2 |

### EXAMPLE 3

### Enhancement of Daily Cleaner

The ability of chitin derivatives to enhance the cleaning ability of an existing product for daily cleaning of contact lenses was evaluated by means of the procedures described in Example 2 above, except that the soiled lenses were treated with test solutions in a water bath shaker/incubator for shorter periods of time (i.e., 10 minutes and 30 minutes). The compositions evaluated were prepared by adding ethylene glycol chitin and carboxymethyl chitin to Clerz® Plus Lens Drops (Alcon Laboratories, Inc.), which contains two surfactants as cleaning agents. The results are set forth in Table 5, below.

TABLE 5
Cleaning Efficacy of Rewetting/Comfort Drops,
with and without Chitin Derivatives

| | % Cleaning: | | | |
|---|---|---|---|---|
| Solutions | 10 Min | STDV | 30 Min | STDV |
| 0.9% NaCl, pH 7.0 | 9.1 | 0.9 | 13.3 | 3.5 |
| Clerz ® Plus | 15.0 | 3.5 | 15.6 | 1.9 |
| Clerz ® Plus/0.2% EG-Chitin | 11.9 | 0.1 | 22.3 | 3.1 |
| Clerz ® Plus/0.2% | 17.3 | 0.4 | 26.0 | 2.9 |
| CM-Chitin | | | | |

The results shown above confirm that ethylene glycol chitin and carboxymethyl chitin enhance the cleaning efficacy of surfactant-based cleaners.

### EXAMPLE 4

### Enhancement of Cleaning at Elevated Temperatures

The ability of the formulations of the present invention to clean contact lenses at elevated temperatures has also been evaluated. The solutions tested contained ethylene glycol chitin (“EGC”) in a commercially available saline solution (Unisol 4) at a concentration of 0.2 w/v %. The solutions had a pH of 7.45 and osmolalities of 229 mOsm. The cleaning procedures utilized were essentially the same as in Example 2, except that the soaking of soiled lenses with the test solution was conducted at three different temperatures (room temperature/25° C., 37° C., and 50° C.) in a water bath shaker/incubator for 5 hours. The results presented in Table 6 below demonstrate that cleaning is accelerated at elevated temperatures. The results are expressed as the amount (i.e., micrograms) of lysozyme removed.

TABLE 6
Temperature Effect on the Cleaning Efficacy of Ethylene Glycol Chitin

| | Amount | Amount | Total | |
|---|---|---|---|---|
| Solution | Removed | Remaining | Deposit | % Cleaning |
| EGC/Unisol (RT) | 111.2 | 328.9 | 440.1 | 25.3 |
| EGC/Unisol (37° C.) | 159.7 | 294.7 | 454.4 | 35.1 |
| EGC/Unisol (50° C.) | 202.7 | 236 | 438.7 | 46.2 |

*Acuvue lenses deposited with lysozyme at 37° C. for 24 hours were used.
**“No-rub” regimen at various temperatures for 5 hours was applied.

### EXAMPLE 5

### Assessment of Desiccation Protection

The desiccation protection capability of formulations containing chitin derivatives was evaluated by a method using the viability dye, 3-[4,5-dimethylthiazol-2-yl]-2,5-diphenyltetrazolium bromide (MTT), with a human corneal epithelial cell culture (CEPI 17). MTT is a tetrazolium salt, which has been used to develop a quantitatively colorimetric assay for mammalian cell survival and proliferation. The assay detects living, but not dead cells. This method was utilized to assess the drying protection capability of compositions of the present invention by measuring the cell viability after exposure to the test solution, followed by drying in an airflow hood.

The assay was conducted in a cell culture plate containing 96 or 48 wells. When the cells reached the confluent stage, the medium was removed and the cells in each well were added with the test solution. After 10 minutes exposure at 37° C., the solution was removed and the cells were left inside an airflow hood to dry for 30 to 60 minutes. 100 or 200 μl of MTT solution was then added to each well and the plate was incubated at 37° C. for 4 hours. The MTT formazan blue crystals produced by the viable cells became visible after incubation. An aliquot of acidic isopropanol was added to dissolve the blue precipitate after carefully removing the solution from the well. A microplate reader at 570 nm was used to determine the intensity of the color solution. The wells with serum/medium and the wells with vehicle solution were also run in the same plate as a total viable and a dead control respectively. The results are presented in Tables 7 and 8 below:

TABLE 7
Desiccation Protection of Chitin Derivatives in Unisol 4 Vehicle

| Formulations | % Protection | STDV | mOsm | pH |
|---|---|---|---|---|
| Ethylene glycol-Chitin 0.5% | 71.1 | 9.9 | 305 | 7.08 |
| Carboxymethyl-Chitin 0.5% | 69.7 | 6.3 | 299 | 7.28 |
| 50% Deacetylated Chitin 0.5% | 67.4 | 4.8 | 309 | 7.05 |
| Unisol 4 ® (Vehicle) | 27.3 | 17.6 | 295 | 7.00 |
| Tears Naturale II ® | 83.2 | 12.4 | 292 | 7.00 |

TABLE 8
Desiccation Protection of Chitin Derivatives in Polyquaternium-1
Formulation

| | Desiccation | |
|---|---|---|
| Solutions | Protection (%) | SDTV |
| 0.2% Ethylene glycol-Chitin | 70.5 | 15.3 |
| 0.2% Carboxymethyl-Chitin | 93.6 | 26.2 |
| 0.25% Deacetylated Chitin (50%) | 71.0 | 7.5 |
| 0.5% Ethylene glycol-Chitin | 74.6 | 9.5 |
| 0.5% Carboxymethyl-Chitin | 100.0 | 8.3 |
| Tears Naturale II ® | 82.1 | 10.4 |
| Tears Naturale Forte ® | 84.1 | 12.1 |
| Vehicle | 23.0 | 2.3 |
| HBSS Control | 26.2 | 3.4 |

*Cells: CEPI 17, p97, a human corneal epithelial cell line.
*Assayed by MTT viability assay and 40 minutes desiccation.
*Vehicle: Sorbitol/Boric Acid/NaCl/Citrate/Polyquaternium-1 (1.5%/0.6%/0.32%/0.6%/11 ppm), pH 7.0.

### EXAMPLE 6

### Evaluation of Anti-microbial Activity of Polyquaternium-1 in Presence of Ethylene Glycol Chitin

The possible impact of chitin derivatives on the antimicrobial activity of the antimicrobial agent polyquaternium-1 was evaluated. The formulations of the solutions utilized in the evaluation are shown in Table 9 below. The testing procedures were as follows:

A 0.1 mL volume of inoculum (10⁸ colony forming units/mL) was first added to a 10 mL volume of the disinfecting solution containing polyquaternium-1 and ethylene glycol chitin. The solutions were maintained at room temperature throughout the test. Each microorganism and test solution was tested individually. Sets of four replicate (n=8) samples were tested for each organism. At selected time intervals of 6 and 24 hours, a 1 mL volume of the inoculated test solution containing Candida albicans, Serratia marcescens, and Staphylococcus aureus was removed and appropriate serial dilutions were made in sterile 0.9% sodium chloride solution dilution blanks. Pour-plates were prepared with soybean-casein digest agar containing 0.07% Asolectin and 0.5% polysorbate 80. At time 0, a 1.0 mL volume of the saline control was removed and serial dilution pour-plates were prepared using the recovery medium and dilution blanks. The time 0 saline control count was used as the initial count. The pour-plates were incubated at 30°-35° C. for appropriate incubation periods. The number of surviving organisms at each time interval was then determined. The test results expressed as log reductions are presented in Table 9 below.

TABLE 9
The Effect of Ethylene Glycol Chitin on the Antimicrobial Activity of
Polyquaternium-1 Formulations

| | Formulation Numbers/Concentrations | | |
|---|---|---|---|
| | (w/v %) | | |
| Component | 9198-17J | 9198-17C | 9198-17C |
| Polyquaternium-1 | 0.0011 | 0.0011 | 0.0011 |
| Sorbitol | 1.5 | 1.5 | 1.5 |
| Boric Acid | 0.6 | 0.6 | 0.6 |
| Sodium Chloride | 0.32 | 0.32 | 0.32 |
| Ethylene Glycol Chitin | 0 | 0.2 | 0.5 |
| pH | 7.0 | 7.0 | 7.0 |

| Microorganism | | Log₁₀ Reduction of Survivors: | | |
|---|---|---|---|---|
| Candida albicans: | 6 hr | 1.3 | 1.0 | 1.1 |
| | 24 hr | 2.3 | 2.3 | 2.7 |
| Serratia marcescens: | 6 hr | 3.3 | 3.6 | 4.4 |
| | 24 hr | 6.2 | 6.2 | 6.2 |
| Staphylococcus aureus: | 6 hr | 5.2 | 4.9 | 4.8 |
| | 24 hr | 6.2 | 6.2 | 6.2 |

### EXAMPLE 7

### Enhancement of Cleaning Efficacy in Commercial Contact Lens Disinfecting Solutions

The ability of ethylene glycol chitin (“EGC”) to enhance the cleaning efficacy of commercially available multi-purpose solutions was evaluated, in accordance with the procedures described in Example 2. The solutions tested were as follows:

1. OPTI-FREE® Express® Multi-Purpose Disinfecting Solution (“OPFX/MPDS”), which is marketed by Alcon Laboratories, Inc.;

2. OPTI-FREE® Rinsing, Disinfecting and Storage Solution (“OPF/RDS”), which is marketed by Alcon Laboratories, Inc.;

3. SOLOCare Plus Multi-Purpose Solution (“SOLOCare Plus”), which is marketed by CibaVision;

4. COMPLETE™ Moisture Plus Multi-purpose Solution (“Complete Moisture Plus”), which is marked by Allergan; and

5. ReNu Multiplus™ Multi-Purpose Solution with Hydranate™ Protein Remover (“ReNu Multiplus”), which is marketed by Bausch & Lomb, Inc.

The results of the evaluation are shown in Table 10, below:

TABLE 10

| | % Cleaning Efficacy | | | | |
|---|---|---|---|---|---|
| Solutions | w/o EGC | STDV | w/c EGC | STDV | Primary Components |
| OPFX/MPDS | 41.4 | 6.0 | 47.3 | 5.8 | Polyquaternium-1/MAPDA/Borate/ |
| | | | | | EDTA/ Tetronic ® 1304/Citrate/AMP |
| OPF/RDS | 34.8 | 0.7 | 44.5 | 0.9 | Polyquaternium-1/Borate/ |
| | | | | | EDTA/ Citrate |
| SoloCare Plus | 16.9 | 5.5 | 43.4 | 5.6 | PHMB/Bis Tris Propane/EDTA/ |
| | | | | | Pluronic ® F127/ Cremophor RH40 |
| Complete | 18.0 | 5.2 | 44.4 | 5.8 | PHMB/Phosphate/EDTA/ |
| Moisture Plus | | | | | Poloxamer/HPMC/Taurine |
| ReNu MultiPlus | 8.3 | 5.3 | 35.9 | 5.8 | PHMB/Borate/EDTA/ |
| | | | | | Poloxamine/Hydranate ® |

The results demonstrate that the inclusion of ethylene glycol chitin enhanced the cleaning efficacy of the solutions.

### EXAMPLE 8

### Enhancement of Cleaning Efficacy in Polyquaternium-1/MAPDA Formulations

The ability of ethylene glycol chitin to enhance the cleaning efficacy of multi-purpose solutions containing the antimicrobial agents polyquaternium-1 and MAPDA was evaluated in accordance with the procedures described in Example 2. The compositions of the solutions are shown in Table 11, below, along with the results of the cleaning efficacy evaluation:

TABLE 11

Formulation (w/v %)

| Component | 10363-87-E | 10581-31D |
|---|---|---|
| Polyquaternium-1 | 0.001 | 0.001 |
| MAPDA | 0.0005 | 0.0005 |
| EGC | 0 | 0.1 |
| Boric Acid | 0.6 | 0.6 |
| Sodium citrate | 0.2 | 0.2 |
| Sodium Chloride | 0.1 | 0.1 |
| Sorbitol | 1.2 | 1.2 |
| Tetronic ® 1304 | 0.05 | 0.05 |
| AMP (95%) | 0.45 | 0.45 |
| EDTA | 0.05 | 0.05 |
| PH | 7.8 | 7.8 |
| % Cleaning Efficacy | 40.5 ± 3.8 | 48.4 ± 2.9 |

We claim:

1. An aqueous composition for cleaning contact lenses, comprising an effective amount of a chitin derivative that is soluble in aqueous solutions at a pH of 6.5 to 8.5 and is capable of binding with and functioning as a substrate for lysozyme, and an ophthalmically acceptable aqueous vehicle for said chitin derivative.

2. A composition according to claim 1, wherein the chitin derivative is nonionic.

3. A composition according to claim 1, wherein the chitin derivative includes anionic functional groups.

4. A composition according to claim 1, wherein the chitin derivative has a molecular weight of 500 to 10,000,000 Daltons.

5. A composition according to claim 1, wherein the chitin derivative is selected from the group consisting of ethylene glycol chitin, propylene glycol chitin, hydroxypropyl chitin, carboxymethyl chitin, partially deacetylated chitin, oligomers of chitin containing 2 to 500 N-acetylglucosamine units, and combinations thereof.

6. A composition according to claim 1, wherein the chitin derivative comprises ethylene glycol chitin.

7. A composition according to claim 1, wherein the composition is a multi-purpose solution for cleaning and disinfecting contact lenses.

8. A composition according to claim 1, wherein the composition is a s product for rewetting contact lenses.

9. A method of treating a contact lens, which comprising applying a cleaning composition to the lens, said composition comprising an effective amount of a chitin derivative that is soluble in aqueous solutions at a pH of 6.5 to 8.5 and is capable of binding with and functioning as a substrate for lysozyme, and an ophthalmically acceptable aqueous vehicle for said chitin derivative.

10. A method according to claim 9, wherein the chitin derivative is nonionic.

11. A method according to claim 9, wherein the chitin derivative includes anionic functional groups.

12. A method according to claim 9, wherein the chitin derivative has a molecular weight of 500 to 10,000,000 Daltons.

13. A method according to claim 9, wherein the chitin derivative is selected from the group consisting of ethylene glycol chitin, propylene glycol chitin, hydroxypropyl chitin, carboxymethyl chitin, partially deacetylated chitin, oligomers of chitin containing 2 to 500 N-acetylglucosamine units, and combinations thereof.

14. A method according to claim 9, wherein the chitin derivative comprises ethylene glycol chitin.

15. A method according to claim 9, wherein the composition is a multi-purpose solution for cleaning and disinfecting contact lenses.

16. A method according to claim 9, wherein the composition is a product for rewetting contact lenses.
